(19) United States
(12) Patent Application Publication
(10) Pub. No.: US 2026/0106472 A1
(43) Pub. Date: Apr. 16, 2026

(54) POWER STORAGE AND EQUIPMENT CHARGING MODULE

(71) Applicant: Air Burners, Inc., Palm City, FL (US)

(72) Inventor: Brian M. O'CONNOR, Palm City, FL (US)

(21) Appl. No.: 19/330,955

(22) Filed: Sep. 17, 2025

Related U.S. Application Data
(60) Provisional application No. 63/707,980, filed on Oct. 16, 2024.

(51) Int. Cl. H02J 7/00

(52) U.S. Cl. CPC H02J 7/70

(57) ABSTRACT

A power storage and equipment charging module has a transport skid base, a power storage unit supported on the skid base, a charge unit supported on the skid base and connected to the power storage unit, a transverse breezeway across the skid base between the power storage unit and the charge unit, and a roof covering the power storage unit, the charge unit, and the breezeway. The power storage unit is configured to receive and store electrical power from a power source, such as a power generating module equipped to generate electrical power using hot exhaust from a firebox module in which vegetative waste is burned. The charge unit includes one or more charging stations to which electrically powered equipment, such as electronic vehicles and machinery, is connectable for charging using electrical power stored by the power storage unit.

### CROSS-REFERENCE TO RELATED APPLICATION

The present application claims priority to and benefit of U.S. Provisional Ser. No. 63/707,980 filed Oct. 16, 2024, the entire disclosure of which is incorporated herein by reference.

### FIELD OF THE DISCLOSURE

The present disclosure relates to a portable power storage and equipment module for storing electrical power generated by an off-grid power source and recharging electric vehicles and other electrically powered equipment using the stored electrical power.

### BACKGROUND OF THE DISCLOSURE

It is known to clear a site of biomass such as vegetative waste by collecting the vegetative waste and burning it in a firebox, for example an air curtain firebox that minimizes release of particulates during burning. One application of this environmentally friendly technology that is growing in importance is wildfire prevention. The firebox may be a transportable module mounted on a skid base for over the road and off-road trailer transport to a job site remote from the established public power grid, for example a site within a forest and/or in rough terrain.

It is also known to provide a portable power generating module locatable adjacent the firebox module that captures and uses hot exhaust from the firebox to generate and store electrical power, as taught by U.S. Pat. No. 9,644,501. However, providing an internal power storage unit onboard the power generating module limits storage capacity because of space and weight allocated to other equipment onboard the power generating module.

Regulatory provisions are now being adopted that require machinery and equipment used in clearing a site of biomass to be battery powered, and not powered by burning fossil fuels. However, arranging for convenient recharging of electric vehicles and other electrically powered equipment by connecting to a power storage unit onboard the power generating module is challenging and introduces safety risks associated with personnel and electric vehicles gathering near the power generating module next to the firebox. The only alternative is to tow, by truck, a battery pack to an off-site location for recharging the battery pack and then towing the recharged battery pack back to the job site for use as a source to recharge the machinery and equipment at the job site. This is extremely wasteful and time consuming. The truck and transportable battery pack would have to be moved half of the time in an uncharged state. In addition, there is no way to ensure the recharge energy is “green” energy.

Providing a safe and convenient power storage and equipment charging solution for off-grid job sites is an unmet need. Meeting this need will allow for the broad use of battery powered machinery and equipment while reducing the time and cost associated with recharging the power storage unit, and ensuring that the recharging energy comes from an environmentally friendly source.

### SUMMARY OF THE DISCLOSURE

The present disclosure provides a portable power storage and equipment charging module for off-grid job sites to support widespread use of battery powered machinery and equipment in a user-friendly manner. The module reduces the time and cost associated with recharging the power storage unit by which machinery and equipment are recharged, and the module enables the recharging energy to be generated from an environmentally friendly source.

A power storage and equipment charging module according to an embodiment of the disclosure comprises a transport skid base, a power storage unit supported on the skid base, a charge unit supported on the skid base and connected to the power storage unit, a transverse breezeway across the skid base between the power storage unit and the charge unit, and a roof covering the power storage unit, the charge unit, and the breezeway. The power storage unit is configured to receive and store electrical power from a power source, such as a power generating module equipped to generate electrical power using hot exhaust from a firebox module in which vegetative waste is burned. The charge unit includes one or more charging stations to which electrically powered equipment is connectable for charging the electrically powered equipment using electrical power stored by the power storage unit. For example, the one or more charging stations may include at least one electric vehicle charging station and at least one 120 VAC outlet. The transverse breezeway may include shelves for supporting electrically powered equipment and battery packs during charging.

The transport skid base may be a steel weldment having a plurality of attachment members for attaching cables to the transport skid base for lifting, pulling, and/or dragging the module, whereby the module may be lifted by crane to load the module onto and unload the module from a truck bed, and towed to a desired location, for example a site remote from the power grid that is being cleared of vegetation.

### BRIEF DESCRIPTION OF THE DRAWING VIEWS

The nature and mode of operation of the present disclosure will now be more fully described in the following detailed description taken with the accompanying drawing figures, in which:

FIG. 1 is a generally front perspective view of a power storage and equipment charging module formed in accordance with an embodiment of the present disclosure, wherein an electric vehicle is shown being charged thereby;

FIG. 2 is another generally front perspective view of the power storage and equipment charging module shown in FIG. 1;

FIG. 3 is a generally rear perspective view of the power storage and equipment charging module shown in FIG. 1;

FIG. 4 is a front elevational view of the power storage and equipment charging module shown in FIG. 1;

FIG. 5 is a rear elevational view of the power storage and equipment charging module shown in FIG. 1;

FIG. 6 is a side elevational view of the power storage and equipment charging module shown in FIG. 1;

FIG. 7 is a sectional view of a portion of the power storage and equipment charging module take generally along the line A-A in FIG. 6; and

FIG. 8 is a perspective view looking into a breezeway of the power storage and equipment charging module shown in FIG. 1.

### DETAILED DESCRIPTION

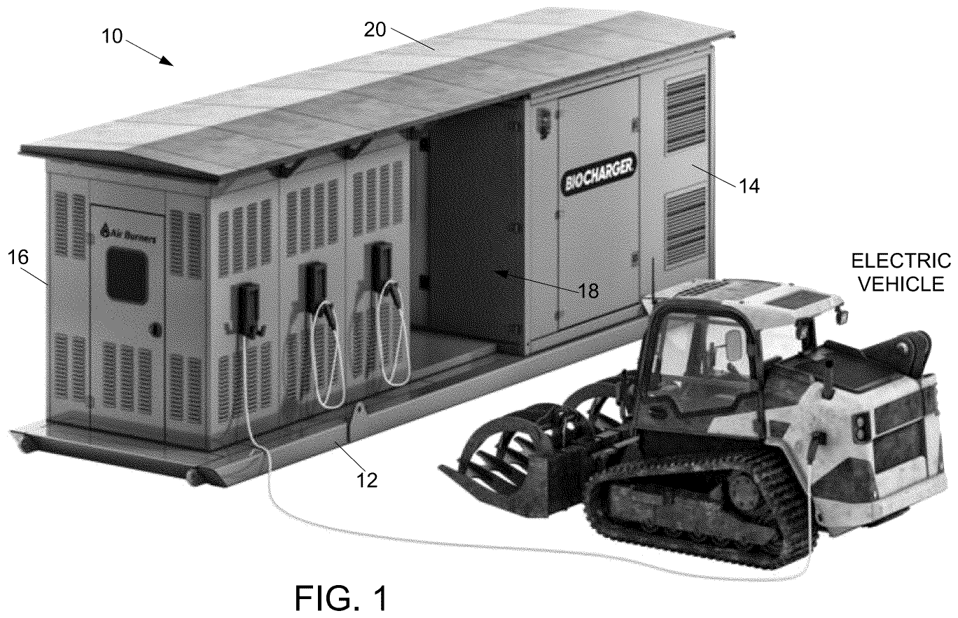

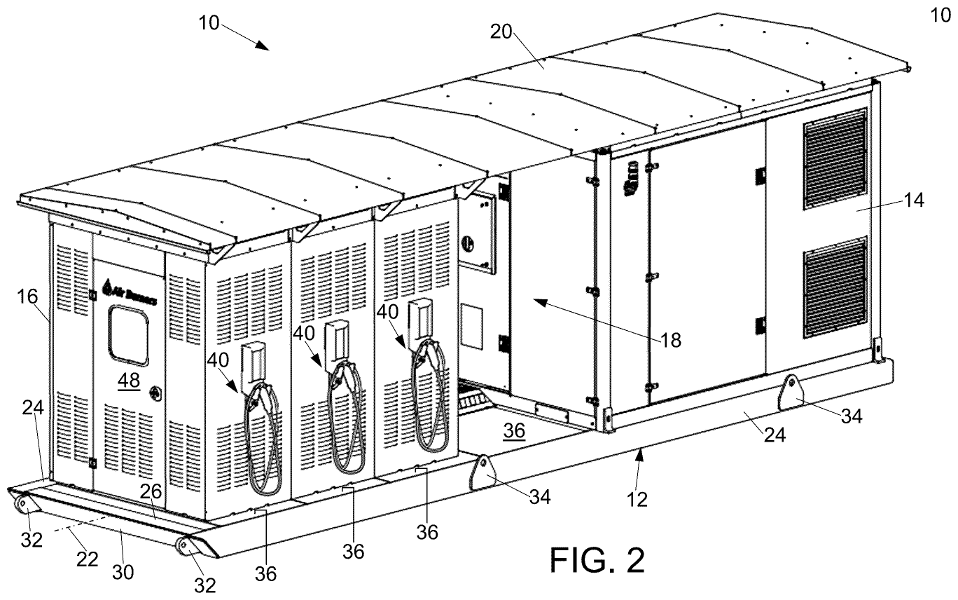

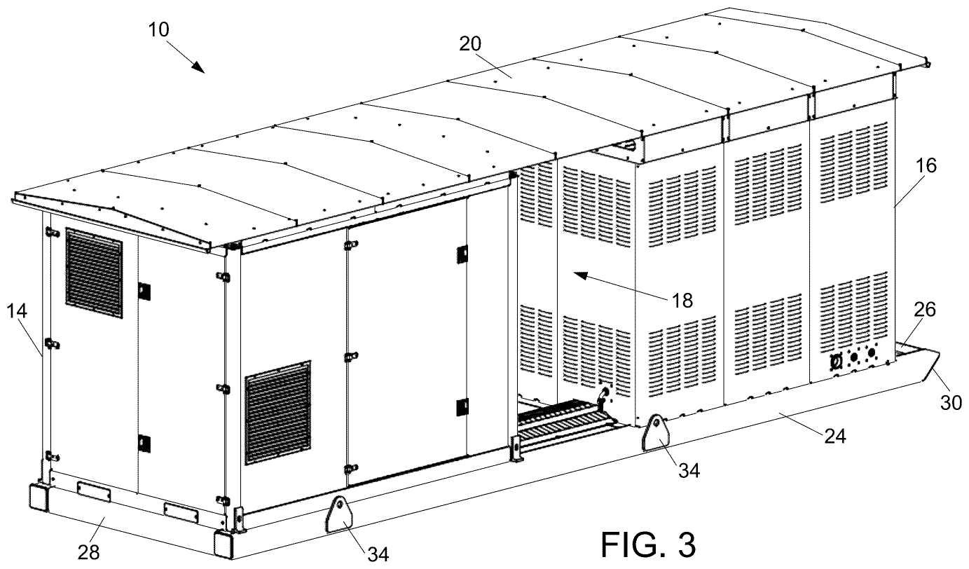

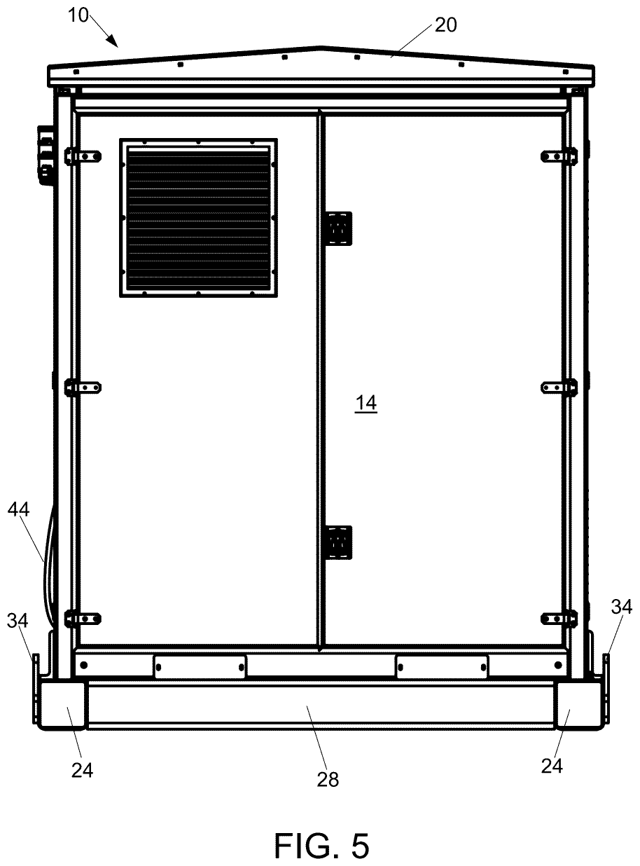

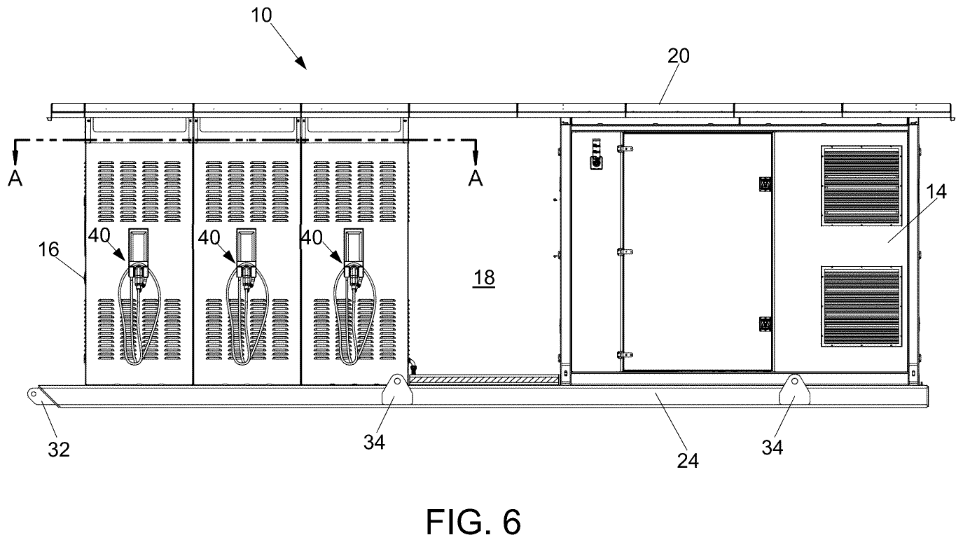

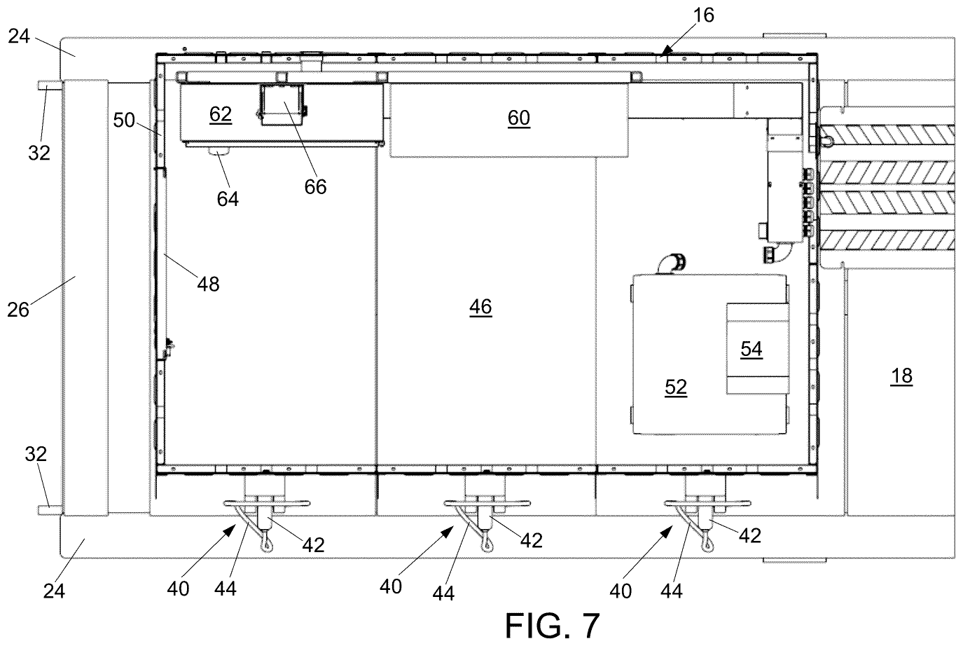

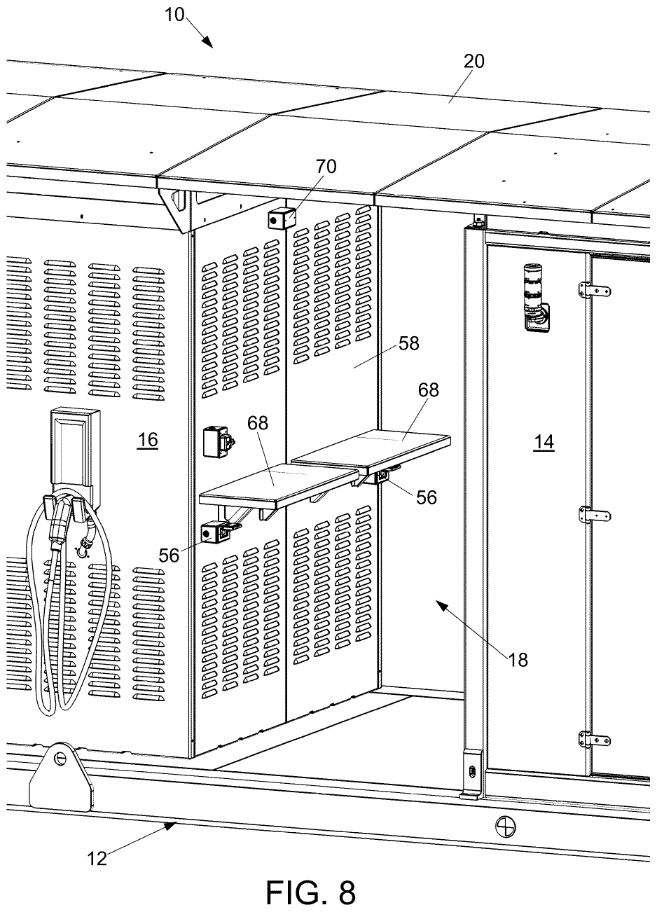

FIGS. 1-8 show a power storage and equipment charging module 10 formed in accordance with an embodiment of the present disclosure. Module 10 may be used in conjunction with a firebox module (not shown) for burning vegetative waste and a power module (not shown) equipped to generate electrical power using hot exhaust from the firebox module. Module 10 may be connected to the power module to receive and store electrical power generated by the power module for use “on site” at a location off the public power grid as described further below.

Module 10 generally comprises a steel transport skid base 12, a power storage unit 14, a charge unit 16, a transverse breezeway 18 between the power storage unit and the charge unit, and a roof 20 covering the power storage unit, the charge unit, and the breezeway.

Skid base 12 may be a steel weldment that is generally rectangular in overall shape and configured to allow module 10 to be lifted by crane, dragged around a site by tractor, and pulled by a winch onto a trailer for roadway transport. In the illustrated embodiment, skid base 12 is elongated along a central axis 22 and may include a pair of transversely spaced side skid members 24 connected by a front skid member 26 and a rear skid member 28. Front skid member 26 and the front ends of side skid members 24 may be configured to provide a sloped leading surface 30. A pair of attachment members 32 may be arranged to extend forwardly from leading surface 30 and may each include an attachment hole therethrough. One or more additional attachment members 34 may be arranged to extend upwardly from an outer side surface of each side skid member 24 and may each include an attachment hole therethrough. As may be understood, attachment members 32 and 34 may be configured and specified for cable lifting, pulling, and/or dragging of module 10. A plurality of floor plates 36 may span across and be supported by side skid members 24.

Power storage unit 14 may be a commercially available battery pack system. By way of non-limiting example, a 550 kWh MTU EnergyPack QS by Rolls Royce is found to be suitable for practicing the present disclosure. Power storage unit 14 of module 10 may be connected by a power delivery cable to a power module as mentioned above that generates electrical power using hot exhaust from burning vegetative waste.

Charge unit 16 may include one or more electric vehicle (“EV”) charging stations 40 each having an EV charger 42 on an EV charging cable 44. Charge unit 16 may enclose an interior space 46 accessible by way of a door 48. Door 48 may be located in a front wall 50 of charge unit 16 or in another wall of the charge unit. Electronics may be housed within interior space 46 of charge unit 16 for receiving and conditioning power from power storage unit 14 for a variety of purposes. The conditioning electronics may include a transformer 52 connected to receive power from power storage unit 14 and convert the power to AC power suitable for EV chargers 42. For example, EV chargers 42 may be Level 2 EV chargers for efficiently recharging electric vehicles at a job site. Conditioning electronics may also include a 120 VAC mini-power transformer 54 for supplying one or more 120 VAC outlets 56 which may be provided along wall 58 separating breezeway 18 from interior space 46. Additional charging outlets or ports may be provided, for example along wall 58, to enable overnight or anytime charging of tools, lights, communication devices, and any other battery powered machines used at the site. Charge unit 16 may also include a 400 VAC electrical panel 60 and a 480 VAC electrical panel 62 each connected to power storage unit 14. Electrical panel 62 may include a generator input 64 for optional charging of power storage unit 14 using an external generator, for example a diesel generator (not shown). An ethernet communications enclosure 66 may also be housed within interior space 46 of charge unit 16.

Importantly, electrically powered equipment and controls that are part of the firebox module and the power module used to eliminate the vegetative waste may also be powered directly by power generated by the power module and/or by power stored in power storage unit 14. In one embodiment, software associated with power storage unit 14 is programmed to retain a minimum of 20% of the energy stored by power storage unit 14 for use the next day to start and run the firebox module and the power module connected to power storage unit 14 so that the system can once again begin generating power and charging power storage unit 14.

One or more shelves 68 may be supported on wall 58 to extend into breezeway 18 to support tools and other battery-powered equipment while it is being recharged. Shelves 68 are preferably of a “fold out” type so they may be stored substantially flush against wall 58 when not in use.

Breezeway 18 extends across the width of module 10 and has an open entryway on both sides of module 10 for easy access. An overhead light 70 may be provided in breezeway 18, for example mounted on wall 58, for nighttime use of module 10. Breezeway 18 is covered by roof 20, thereby providing protection from the elements.

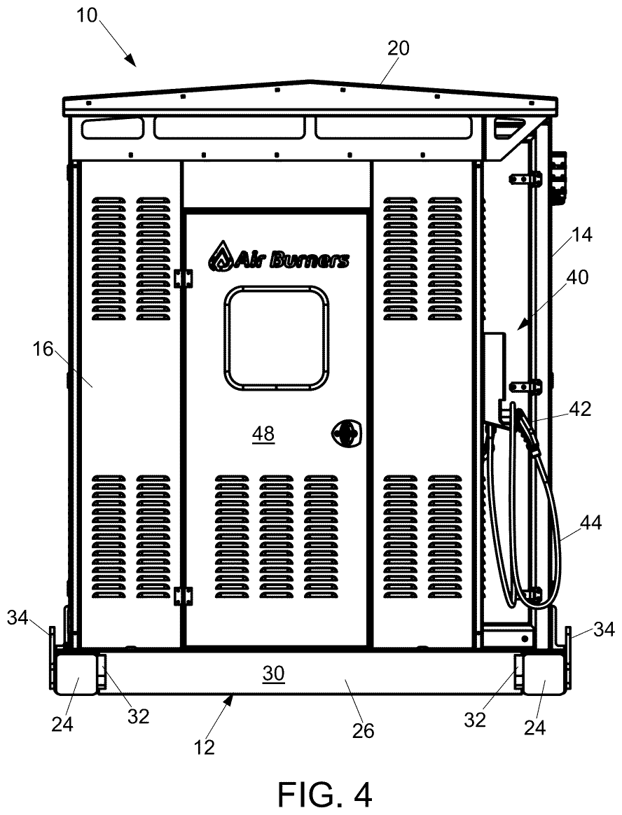

As best seen in FIG. 4, the housing of charge unit 16 may be positioned slightly off-center on skid base 12 and roof 20 may be dimensioned to extend transversely out overtop EV charging stations 40 to cover EV chargers 42 when they are not in use.

As will be understood from the foregoing description, power storage and equipment charging module 10 of the present disclosure provides a safe and convenient power storage and equipment charging solution for off-grid job sites where electrically powered machinery and equipment is used. The time, cost, and energy usage associated with transporting a battery pack to and from a remote charging location away from the job site is eliminated. Moreover, the energy used to recharge power storage and equipment charging module 10—and ultimately the machinery and equipment used at the job site—is “green” energy that is generated through burning vegetative waste as part of the site clearing effort.

While the disclosure sets forth exemplary embodiments, the detailed description is not intended to limit the scope of the disclosure to the particular forms set forth. The disclosure is intended to cover such alternatives, modifications and equivalents of the described embodiments as may be included within the scope of the claims.

What is claimed is:

1. A power storage and equipment charging module comprising:
a transport skid base;
a power storage unit supported on the skid base, the power storage unit being configured to receive and store electrical power from a power source;
a charge unit supported on the skid base and connected to the power storage unit, the charge unit including one or more charging stations to which electrically powered equipment is connectable for charging the electrically powered equipment using electrical power stored by the power storage unit;
a transverse breezeway across the skid base between the power storage unit and the charge unit; and
a roof covering the power storage unit, the charge unit, and the breezeway.

2. The module according to claim 1, wherein the transport skid base is a steel weldment having a plurality of attachment members for attaching cables to the transport skid base for lifting, pulling, and/or dragging the module.

3. The module according to claim 1, further comprising one or more floor plates spanning across the transport skid base through the breezeway.

4. The module according to claim 1, wherein the one or more charging stations include one or more electric vehicle charging stations.

5. The module according to claim 1, wherein the charge unit encloses an interior space and includes an electrical transformer within the interior space for receiving power from the power storage unit and converting the power to AC power suitable for use by the one or more charging stations.

6. The module according to claim 5, wherein the charge unit further includes another electrical transformer within the interior space for supplying electrical power to one or more 120 VAC outlets accessible in the breezeway.

7. The module according to claim 5, wherein the charge unit further includes an electrical panel within the interior space, the electrical panel being connected to the power storage unit, wherein the electrical panel includes a generator input for charging the power storage unit using power from an external generator.

8. The module according to claim 5, wherein the charge unit further includes an ethernet communications enclosure within the interior space.

9. The module according to claim 1, wherein the charge unit is positioned off-center on the skid base, the one or more charging stations are located on an exterior side of the charge unit, and the roof extends transversely out overtop the one or more charging stations.

10. The module according to claim 1, further comprising one or more shelves extending from a wall of the charge unit into the breezeway.

11. The module according to claim 10, wherein the one or more shelves fold relative to the wall of the charge unit for storage substantially flush against the wall of the charge unit when the one or more shelves are not in use.

12. The module according to claim 1, wherein the breezeway extends transversely across a width of the module and has an open entryway on each transverse side of the module.

13. The module according to claim 1, further comprising an light fixture mounted in the breezeway.
